(19) United States
(12) Patent Application Publication
(10) Pub. No.: US 2012/0181464 A1
(43) Pub. Date: Jul. 19, 2012

(54) VALVE

(75) Inventors: Johannes Pfetzer, Buehl (DE); Thomas Kotlarski, Buehl (DE); Anja Schoenemann, Buehl (DE); Joerg Schmid, Achern (DE); Samir Mahfoudh, Buehl (DE)

(73) Assignee: ROBERT BOSCH GMBH, Stuttgart (DE)

(21) Appl. No.: 13/383,033

(22) PCT Filed: Jun. 29, 2010
(86) PCT No.: PCT/EP10/59169

§ 371 Date: Mar. 23, 2012

(30) Foreign Application Priority Data
Jul. 8, 2009 (DE) 10 2009 027 527.4

(51) Int. Cl. F16K 1/42; F16K 31/06

(52) U.S. Cl. 251/129.15; 251/333

(57) ABSTRACT

The invention relates to a valve (100, 101) comprising a housing (110, 111), an annular sealing element (140, 146), and a displaceable closure element (170), wherein the sealing element (140, 146) and the closure element (170) are disposed within the housing (110, 111), and wherein the valve (100, 101) can be closed by placing the closure element (170) against the sealing element (140, 146). The valve (100, 101) is characterized by a hollow space (131, 132) in the region of an outer side of the sealing element (140, 146), in which a part (143, 144) of the sealing element (140, 146) can be received during thermal expansion. The invention further relates to another valve (102) in which the annular sealing element is an O-ring (150).

### BACKGROUND OF THE INVENTION

The present invention relates to a valve which comprises a housing, an annular sealing element and a movable closing element.

Valves are used to control the volumetric flow of gases and liquids. A possible area of use is, for example, the cooling circuit of a motor vehicle in which the engine of the motor vehicle is cooled by means of a cooling liquid, and the heated cooling liquid is used, if appropriate, for vehicle heating purposes. The distribution of the coolant to various branches of the cooling or heating circuit is controlled by means of electrically controllable valves.

A conventional valve in a cooling circuit of a motor vehicle comprises a valve housing and, within the housing, an annular sealing element and a closing element in the form of a sealing cone. The sealing element is braced via a spacer sleeve against an end stop of the housing. The closing element is connected to a lifting rod which is mounted displaceably inside the housing and via which the closing element can be placed against the sealing element in order to close the valve. The lifting rod is additionally fastened to a tension spring which exerts on the lifting rod a force which pulls the closing element away from the sealing element.

To actuate the valve, a yoke arranged on the housing and an armature connected to the lifting rod are provided. An electromagnetic attraction force which acts counter to the spring force and counter to a coolant pressure (generated by a pump) can be produced between the armature and yoke, with the result that an opening and closing of the valve can be controlled. When the valve is in the closed state, the armature and yoke usually have a residual distance from one another.

High coolant temperatures can adversely affect the closing behavior in the valve. A particular problem is a thermal expansion of the annular sealing element, the axial component of which expansion leads to an increase in the residual distance between the armature and yoke when the valve is closed. This is associated with a reduction in the electromagnetic closing force, with the result that the valve can have a leak.

### SUMMARY OF THE INVENTION

The object of the present invention is to provide an improved valve which allows a better and more robust closing behavior, in particular at high temperatures.

According to the invention, a valve is proposed which comprises a housing, an annular sealing element and a movable closing element. The sealing element and the closing element are arranged within the housing. The valve can be closed by placing the closing element against the sealing element. The valve is distinguished by a cavity in the region of an outer side of the sealing element, in which cavity a part of the sealing element can be received during a thermal expansion.

The design of the valve with a cavity in the region of an outer side, that is to say a (radially) outwardly directed side of the annular sealing element, offers a clearance for a temperature-induced deformation (volume increase) of the sealing element, with the result that an axial expansion of the sealing element can be reduced. In this way, leaktightness problems associated with the axial deformation can be reduced or avoided, with the result that the valve has a more robust closing behavior.

In a preferred embodiment, the cavity is provided between the outer side of the sealing element and an inner side of the housing that is situated opposite the outer side of the sealing element. In such a configuration, the sealing element preferably has, in the region of the cavity, a sealing lip which bears against the inner side of the housing, with the result that a high degree of leaktightness can be achieved for the valve.

In a further preferred embodiment, the valve further comprises a hollow-cylindrical spacer sleeve arranged inside the housing, which sleeve bears against the sealing element and presses the sealing element against an end stop of the housing. In this way, the sealing element is reliably fastened inside the housing.

In a further preferred embodiment, the spacer sleeve bears against the sealing element only in the region of an outer circumference and in the region of an inner circumference of the sealing element. It is thereby possible to avoid the situation in which a thermal expansion of the spacer sleeve (in addition to the thermal expansion of the sealing element) leads to an axial deformation of the sealing element, in particular in the region of the inner circumference, which adversely affects the closing behavior.

Such a configuration can be achieved, for example, with a spacer sleeve which has a stepped cross-sectional shape in a region adjoining the sealing element. In this case, the annular sealing element can likewise have a stepped cross-sectional shape with a lower portion and an upper portion, wherein one cavity is provided in the region of an outer side of the lower portion and a further cavity is provided in the region of an outer side of the upper portion.

According to the invention, there is furthermore proposed a valve which comprises a housing, an annular sealing element and a movable closing element. The sealing element and the closing element are arranged within the housing. The valve can be closed by placing the closing element against the sealing element. The valve is distinguished by the fact that the annular sealing element is an O-ring.

The design of the sealing element as an O-ring also makes it possible to reduce a temperature-induced axial expansion of the sealing element, with the result that the valve has a more robust closing behavior. Particularly by comparison with a conventional sealing element, the O-ring can have a relatively small volume, resulting in a relatively small thermal expansion. The O-ring also offers the possibility of fastening without a spacer sleeve, thereby making it possible to avoid problems associated therewith.

For fastening purposes, it is proposed in a preferred embodiment to provide the sealing element as an O-ring which is integrally formed on the housing by means of two-component injection molding. In this way, the O-ring is fixed on the valve housing in a relatively reliable and stable manner.

### BRIEF DESCRIPTION OF THE DRAWINGS

The invention will be explained in more detail below with reference to the appended figures, in which:

FIG. 1 shows a schematic lateral sectional representation of a valve with an annular sealing element and cavities for an expansion of the sealing element;

FIG. 2 shows a schematic representation of a lower region of the valve of FIG. 1 to illustrate a radial expansion of the sealing element;

FIG. 3 shows a schematic representation of the annular sealing element of the valve of FIG. 1 to illustrate an axial expansion;

FIG. 4 shows a schematic lateral sectional representation of a further valve with an annular sealing element and cavities for an expansion of the sealing element;

FIG. 5 shows a schematic lateral sectional representation of a further valve with an O-ring as sealing element; and

FIG. 6 shows a schematic representation of a lower region of the valve of FIG. 5 to illustrate an axial expansion of the O-ring.

### DETAILED DESCRIPTION

Possible embodiments of electrically controllable valves are described with reference to the figures which follow. The valves, which can be used, for example, in a coolant circuit of a motor vehicle, are distinguished by a robust closing behavior which is ensured even with temperature-induced deformations of valve components.

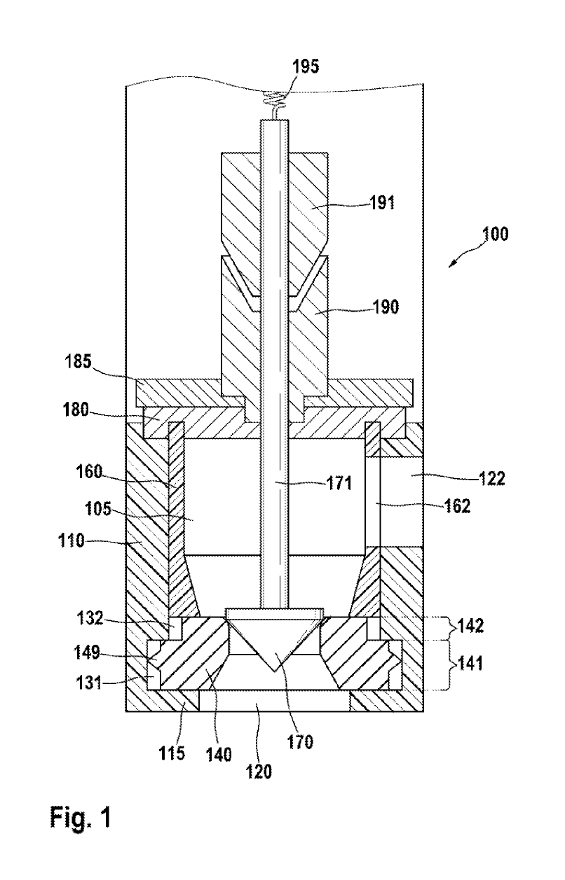

FIG. 1 shows a schematic lateral sectional representation of a valve 100. The valve 100 comprises a housing 110 which encloses a substantially hollow-cylindrical interior 105. On the housing 110, which comprises, for example, a plastics material, are provided a lower connection opening 120 and a lateral connection opening 122. The interior 105 of the valve housing is accessible to a medium via the asymmetrically arranged connection openings 120, 122. With regard to the above-described coolant circuit of a motor vehicle, the lower connection opening 120 is used, for example, for feeding in a cooling liquid (conveyed via a pump), and the lateral connection opening 122 is used for discharging the cooling liquid (not shown).

In the interior 105, the valve 100 further comprises an annular sealing element 140, referred to hereinafter as a sealing ring 140, and a closing element 170 which interacts with the sealing ring 140 and which is designed as a sealing cone 170. The sealing cone 170 comprises, for example, a metallic material, for example brass. The sealing ring 140, which is formed from an elastically deformable material, such as, in particular, an elastomer material, has on each side, as seen in cross section, a respectively stepped design with a lower portion 141 and a narrower upper portion 142. On its upper side, the upper portion 142 has a rounded-off contour in the region of an inner circumference of the sealing ring 140. In this region, as depicted in FIG. 1, the sealing cone 170 can bear against the sealing ring 140, with the result that the valve 100 is closed. The lower portion 141 of the sealing ring 140 has, in the region of the inner circumference, a shape which widens out in the direction of the lower connection opening 120. Further details on the design of the sealing ring 140 are explained more fully further below.

To fix the sealing ring 140 inside the housing 110, the valve 100 comprises a hollow-cylindrical spacer sleeve 160 which bears against the inner side of the housing 110 and which is formed, for example, from a plastics material. By means of the spacer sleeve 160, the sealing ring 140 is braced against an end stop 115 of the housing 110 that is present in the region of the lower connection opening 120. As indicated in FIG. 1, the spacer sleeve 160 has a lateral opening 162 which is tailored to the lateral connection opening 122 of the housing 100, so as to allow a volumetric flow from the housing interior 105 across the connection opening 122. In a portion adjoining the sealing ring 140, the spacer sleeve 160 also has, in cross section, a shape which widens in the direction of the sealing ring 140.

On an upper side of the housing 110, the valve 100 has a connection plate 185 which is fastened to the housing 110 using fastening means, such as, for example, screws (not shown). On a lower side of the connection plate 185 there is provided a sealing collar 180 which rests on the spacer sleeve 160 and presses the spacer sleeve 160 in the direction of the sealing ring 140, thereby producing the above-described bracing of the sealing ring 140 against the end stop 115.

The sealing cone 170, which interacts with the sealing ring 140, is connected to a lifting rod 171 or is integrally formed on the lifting rod 171. The lifting rod 171 is mounted displaceably such that the valve 100 can be closed and opened or such that a volumetric flow through the valve 100 across the connection openings 120, 122 can be controlled. In the position shown in FIG. 1, in which the sealing cone 170 bears against the sealing ring 140, the valve 100 is closed, which means that no volumetric flow is possible between the connection openings 120, 122.

On the upper side, the lifting rod 171 passes out of the valve housing 110 through the sealing collar 180. In the region of the lifting rod 171, the sealing collar 180 can be embodied as a sealing bush or comprise such a sealing bush, in order to seal the lifting rod 171 as it is guided through. At an upper end, the lifting rod 171 is connected to a tension spring 195 which exerts on the lifting rod 171 a force which pulls the sealing cone 170 away from the sealing ring 140 and thus opens the valve 100.

To move the lifting rod 171, and hence the sealing cone 170, in the direction of the sealing ring 140, and consequently to close the valve 100, the valve 100 comprises a yoke 190 and an armature 191 which can both be designed to be substantially cylindrical. In this arrangement, the lifting rod 171 is guided in its central position through the yoke 190, and the armature 191 is fastened circumferentially on the lifting rod 171 in an upper region thereof. The yoke 190, which is provided on an upper side with respect to the housing 110 and is arranged on or fastened to the connection plate 185, has a cone-like recess on an upper side. The armature 191 has, on a lower side, a conical portion which corresponds in its contour substantially to the contour of the cone-like region of the yoke 190.

The armature 191 and yoke 190 are designed in such a way that an electromagnetic attraction force can be produced between these components in order to draw the armature 191, which is fastened to the lifting rod 171, in the direction of the yoke 190 and consequently to displace the sealing cone 170 in the direction of the sealing ring 140. For this purpose, the armature 191 can be designed, for example, as an electrically controllable electromagnet, and the yoke 190 can be designed as a permanent magnet. Here, the electromagnetic force between the armature 191 and yoke 190 acts against the tensile force of the spring 195 and against a pressure (produced by a pump and acting on the bottom connection opening 120) of a medium or coolant. Therefore, the opening and closing of the valve 100 can be controlled via the electromagnetic attraction force or a variation thereof. As represented in FIG. 1, even when the valve is in the closed state, a residual distance is provided between the armature 191 and yoke 190 in order, for example, to compensate for component tolerances.

The valve 100 is distinguished by a robust closing behavior, this being ensured in particular at high temperatures or during changes in temperature and during an associated thermal expansion (volume increase) of the sealing ring 140. High temperatures can be caused by medium flowing through the valve 100. In the case of the aforementioned coolant circuit of a motor vehicle, the coolant used can heat up, for example, to a temperature of about 110° C.

To achieve a reliable closing behavior, the valve 100 has, in the region of an outer side of the sealing ring 140, that is to say a (radially) outwardly directed side, a lower cavity 131 adjoining the lower sealing ring portion 141 and an upper cavity 132 adjoining the upper sealing ring portion 142. The cavities 131, 132 offer a clearance for a temperature-induced radial deformation of the sealing element 140, with the result that, unlike in a conventional valve, an axial expansion of the sealing ring 140 can be largely suppressed. For the lower cavity 131, a recess or groove which extends (radially) around the housing inner side is formed in the housing 110 in the region of the end stop 115 and is filled by a part of the lower sealing ring portion 141. This makes it possible (in addition to the use of the spacer sleeve 160) to achieve a (partial) fixing of the sealing ring 140. Here, the lower cavity 131 is bounded by the sealing ring 140 and the inner side of the housing 110. By contrast, the upper cavity 132 is bounded by the sealing ring 140, the housing inner side situated opposite the sealing ring 140 or sealing ring portion 142, and, in addition, a part of the spacer sleeve 160.

The lower sealing ring portion 141 is additionally provided on its outer side with a peripheral sealing lip 149 which bears against the inner side of the housing 110, in order to ensure a high degree of leaktighness of the valve 100. In this way, the lower cavity 131 is subdivided into two “sub-cavities”. In addition, or as an alternative, such a sealing lip can also be provided (not shown) on the upper sealing ring portion 142.

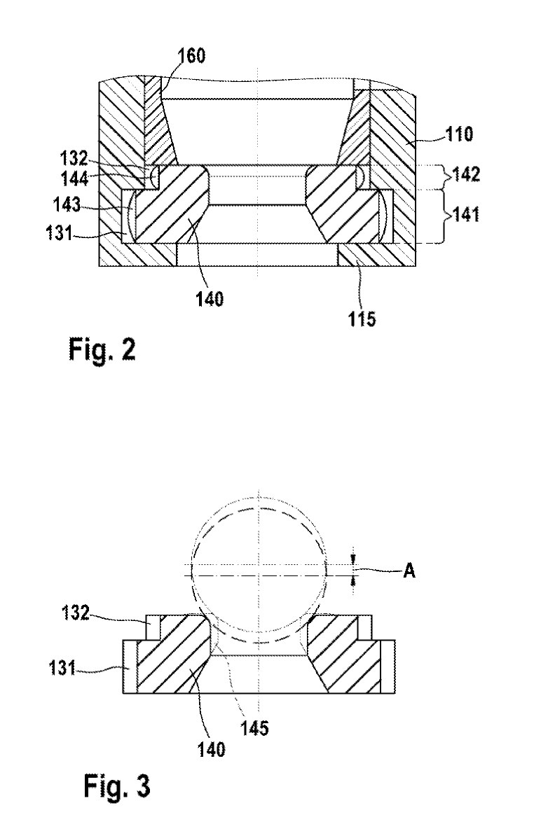

As described above, the cavities 131, 132 serve to accommodate a part of the sealing ring 140 during a temperature-induced radial expansion. In the schematic detail view of a lower region of the valve 100 of FIG. 2, such an expansion is indicated by way of deformations 143, 144 of the lower and upper sealing ring portions 141, 142, with the sealing lip 149 having being left out of the representation. Here, the radial deformations 143, 144 can be accommodated in the cavities 131, 132, with the result that an axial deformation of the sealing ring 140 occurs to a relatively small extent.

For illustration purposes, FIG. 3 shows a bulging or deformation 145 of the sealing ring 140 that occurs during a thermal expansion of the sealing ring 140. Owing to the spacer sleeve 160, which bears further outwardly against the sealing ring 140, the deformation 145 occurs on the upper side in particular in the region of the inner circumference of the sealing ring 140, thus at a point at which the sealing cone 170 bears (with the valve 100 closed) against the sealing ring 140. The deformation 145 is associated with an axial expansion A, as is illustrated by way of offset dashed circles. The axial expansion A causes the sealing cone 170 bearing against the sealing ring 140 (and hence the lifting rod 171 and the armature 191 with respect to the yoke 190) to be displaced axially, with the result that the residual distance between the armature 191 and yoke 190 is increased.

Owing to the radial thermal expansion possibility for the sealing ring 140 provided by the cavities 131, 132, the temperature-induced deformation 145, and hence the axial displacement A, is relatively small in the valve 100. By contrast, in a conventional valve without cavities, no such radial expansion possibility is provided for a sealing ring, with the result that a substantially larger axial deformation, and hence increase in the residual distance between the armature and yoke, occurs. However, the increase in the residual distance results in a reduction in the electromagnetic attraction force, which, in a conventional valve, can assume such an extent that the valve becomes non-leaktight.

The effect associated with the use of the cavities 131, 132 is illustrated by the following exemplary data, which have been obtained by means of tests and simulations on a conventional valve and on a valve with a structure corresponding to the valve 100 of FIG. 1. When heating from room temperature to a temperature of 110° C., an axial expansion occurring in the conventional valve (without cavities) amounted to 0.17 mm, whereas the expansion in the valve equipped with cavities amounted to only 0.06 mm. Such a “minimization” of the axial deformation made it possible to achieve an “increase” in the magnetic force between the armature and yoke of about 1.5N.

In addition to the provision of a thermal expansion possibility for the sealing ring 140, the cavities 131, 132 of the valve 100 are also suited to reducing, for example, component tolerances (in particular of the spacer sleeve 160) and an associated deformation of the sealing element 140. Owing to the expansion or deformation possibility of the sealing ring 140 that is provided by the cavities 131, 132, it is also possible, if appropriate, for a possible inclination of the sealing cone 170 and lifting rod 171 to be compensated.

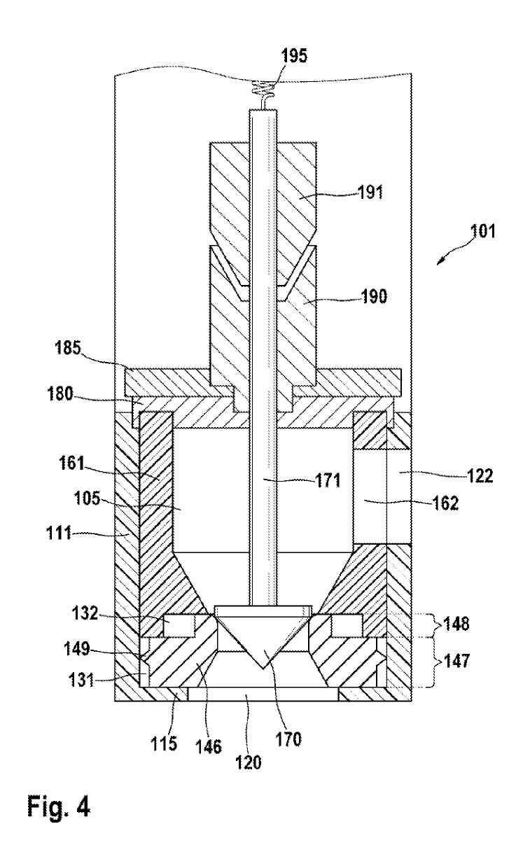

FIG. 4 shows a schematic lateral sectional representation of a further valve 101, which substantially has the same structure as the valve 100 represented in FIG. 1. For details on the mode of operation and on corresponding valve components, reference is therefore made to the above statements.

The valve 101 has a valve housing 111 with asymmetrically arranged connection openings 120, 122, which housing encloses a hollow-cylindrical interior 105. Arranged in the interior 105 is an elastically deformable sealing ring 146 which, for fixing inside the housing 111, is braced by a spacer sleeve 161 against an end stop of the housing 115. An opening 162 corresponding to the connection opening 122 is provided in the spacer sleeve 161. The sealing ring 146 has a stepped cross-sectional shape with a lower portion 147 and a narrower upper portion 148. Likewise provided are a lower and an upper cavity 131, 132 on the outer side of the sealing ring 146, in order to create a radial thermal expansion possibility for the sealing ring 146 and consequently to suppress as far as possible an axial expansion of the sealing ring 146 in a corresponding manner to the valve 100 of FIG. 1.

In contrast to the valve 100, the housing 111 of the valve 101 does not have a peripheral recess for the lower cavity 131 in the region of the end stop 115. The lower cavity 131 is therefore bounded by the sealing ring 146 or sealing ring portion 147, the housing inner side and, in addition, a part of the spacer sleeve 161. Here, as represented in FIG. 4, the sealing ring portion 147 can again have a peripheral sealing lip 149 bearing against the housing inner side.

Furthermore, the spacer sleeve 161, or the lower portion of the spacer sleeve 161 that widens in the direction of the sealing ring 146, is provided on the underside with a step (as seen in cross section), which means that the upper cavity 132 is present only between the sealing ring 146 and the spacer sleeve 161. The lower step-shaped portion of the spacer sleeve 161 and the stepped shape of the sealing ring 146 make it possible here for the spacer sleeve 161 to bear against the upper side the sealing ring 146 only in the region of the outer circumference and in particular in the region of the inner circumference. As a result, it is possible to effectively avoid the situation in which a temperature-induced longitudinal expansion of the spacer sleeve 161 causes, in the region of the inner circumference, a bulging or axial deformation of the sealing ring 146 that adversely affects the closing behavior.

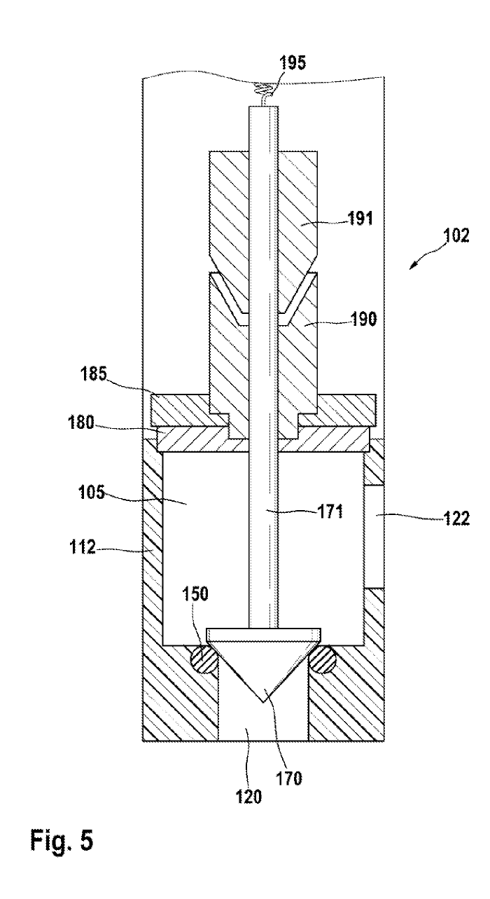

FIG. 5 shows a schematic lateral sectional representation of a further valve 102 which, in terms of the structure, largely corresponds to the valves 100, 101 of FIGS. 1 and 4. For details on the mode of operation and on corresponding valve components, reference is made to the above statements.

The valve 102 has a valve housing 112 with asymmetrically arranged connection openings 120, 122, which housing encloses a hollow-cylindrical interior 105. Provided in the interior 105 is an annular, elastically deformable sealing element 150 which interacts with a sealing cone 170, which is integrally formed on or fastened to a lifting rod 171, in order to close the valve 102. The lifting rod 171, which is mounted displaceably, passes out at an upper side of the housing 112 at which the housing 112 is closed by a connection plate 185 and a sealing collar 180. At an upper end, the lifting rod 171 is connected to a tension spring 195. To actuate the valve 102, a yoke 190 arranged on the housing upper side and an armature 191 fastened to the lifting rod 171 are provided, between which an electromagnetic attraction force can be produced against the tensile force of the spring 195 and against a pressure (produced by a pump and acting on the bottom connection opening 120) of a medium or coolant.

In contrast to the valves 101, 102 of FIGS. 1 and 4, the annular sealing element 150 of the valve 102 is designed as an O-ring 150. Here, the O-ring 150 is provided on the “edge” of a step or of a shoulder inside the housing 112 in a region above the connection opening 120. The O-ring 150 can be realized with relatively small dimensions or with a relatively small volume. Consequently, a temperature-induced expansion (which is approximately proportional to the volume), and hence an axial deformation, are also relatively small.

Furthermore, the use of the O-ring 150 offers the possibility of a fastening without a spacer sleeve, which means that problems associated with a spacer sleeve can be avoided, such as, in particular, a component tolerance and a temperature-induced longitudinal expansion by means of which a sealing element or ring can be (axially) deformed. For reliable and stable fixing, the O-ring 150 is preferably produced together with the housing 112 by carrying out a two-component injection molding process. Here, for example, an elastomer is used for the O-ring 150 and a thermoplastic is used for the housing 112.

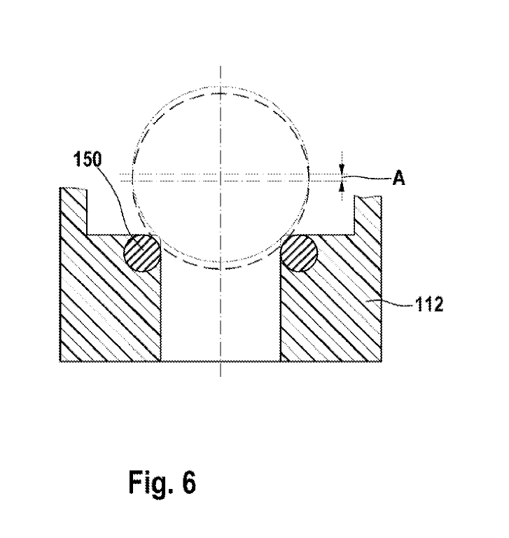

To illustrate the use of the O-ring 150, FIG. 6 shows a thermal expansion of the O-ring 150 and the axial component A thereof (indicated by way of offset dashed circles). By means of tests and simulations on a valve having a structure corresponding to the valve 102 of FIG. 5, the axial expansion determined for the respective O-ring when heating from room temperature to a temperature of 110° C. was only 0.02 mm, which is therefore substantially smaller than the deformation of 0.17 mm obtained on a conventional valve (see above). A temperature-induced decrease in the magnetic force between the armature and yoke is therefore substantially avoided.

The embodiments of valves described with reference to the figures constitute preferred or exemplary embodiments of the invention. Instead of the embodiment described, further embodiments are conceivable which can comprise further modifications of valves, in which cavities are provided on outer sides of annular sealing elements or in which O-ring seals are used. With regard to the provision of outer-side cavities, in particular annular sealing elements are conceivable which can have a different shape (in cross section) than the sealing rings 140, 146. Also, the stated materials of valve components are to be considered as examples which can be replaced by other materials.

1. A valve comprising a housing (110, 111), an annular sealing element (140, 146) and a movable closing element (170), wherein the sealing element (140, 146) and the closing element (170) are arranged within the housing (110, 111), and wherein the valve can be closed by placing the closing element (170) against the sealing element (140, 146) characterized by a cavity (131, 132) in the region of an outer side of the sealing element (140, 146), in which cavity a part (143, 144) of the sealing element (140, 146) can be received during a thermal expansion.

2. The valve as claimed in claim 1, wherein the cavity (131, 132) is provided between the outer side of the sealing element (140, 146) and an inner side of the housing (110, 111) that is situated opposite the outer side of the sealing element (140, 146).

3. The valve as claimed in claim 2, wherein the sealing element (140, 146) has, in the region of the cavity (131), a sealing lip (149) which bears against the inner side of the housing (110, 111).

4. The valve as claimed in claim 1, further comprising a hollow-cylindrical spacer sleeve (160, 161) arranged inside the housing (110, 111), which sleeve bears against the sealing element (140, 146) and presses the sealing element (140, 146) against an end stop (115) of the housing (110, 111).

5. The valve as claimed in claim 4, wherein the spacer sleeve (161) bears against the sealing element (146) only in the region of an outer circumference and in the region of an inner circumference of the sealing element (146).

6. The valve as claimed in claim 1, wherein the annular sealing element (140, 146) has a stepped cross-sectional shape with a lower portion (141, 147) and an upper portion (142, 148), wherein one cavity (131) is provided in the region of an outer side of the lower portion (141, 147) and a further cavity (132) is provided in the region of an outer side of the upper portion (142, 148).

7. The valve as claimed in claim 1, further comprising a yoke (190) arranged on the housing (110, 111) and an armature (191) connected to the closing element (170), wherein the armature (191) can be moved in the direction of the yoke (190) through an electromagnetic interaction between the armature (191) and the yoke (190), and the closing element (170) can thus be placed against the sealing element (140, 146).

8. A valve comprising a housing (112), an annular sealing element (150) and a movable closing element (170), wherein the sealing element (150) and the closing element (170) are arranged within the housing (112), and wherein the valve can be closed by placing the closing element (170) against the sealing element (150), characterized in that the annular sealing element is an O-ring (150).

9. The valve as claimed in claim 8, wherein the sealing element is an O-ring (150) which is integrally formed on the housing (112) by means of two-component injection molding.

10. The valve as claimed in claim 8, further comprising a yoke (190) arranged on the housing (112) and an armature (191) connected to the closing element (170), wherein the armature (191) can be moved in the direction of the yoke (190) through an electromagnetic interaction between the armature (191) and the yoke (190), and the closing element (170) can thus be placed against the sealing element (150).

11. The valve as claimed in claim 3, further comprising a hollow-cylindrical spacer sleeve (160, 161) arranged inside the housing (110, 111), which sleeve bears against the sealing element (140, 146) and presses the sealing element (140, 146) against an end stop (115) of the housing (110, 111).

12. The valve as claimed in claim 11, wherein the spacer sleeve (161) bears against the sealing element (146) only in the region of an outer circumference and in the region of an inner circumference of the sealing element (146).

13. The valve as claimed in claim 12, wherein the annular sealing element (140, 146) has a stepped cross-sectional shape with a lower portion (141, 147) and an upper portion (142, 148), wherein one cavity (131) is provided in the region of an outer side of the lower portion (141, 147) and a further cavity (132) is provided in the region of an outer side of the upper portion (142, 148).

14. The valve as claimed in claim 13, further comprising a yoke (190) arranged on the housing (110, 111) and an armature (191) connected to the closing element (170), wherein the armature (191) can be moved in the direction of the yoke (190) through an electromagnetic interaction between the armature (191) and the yoke (190), and the closing element (170) can thus be placed against the sealing element (140, 146).

15. The valve as claimed in claim 9, further comprising a yoke (190) arranged on the housing (112) and an armature (191) connected to the closing element (170), wherein the armature (191) can be moved in the direction of the yoke (190) through an electromagnetic interaction between the armature (191) and the yoke (190), and the closing element (170) can thus be placed against the sealing element (150).
